(19) United States
(12) Patent Application Publication
(10) Pub. No.: US 2024/0280925 A1
(43) Pub. Date: Aug. 22, 2024

(54) DEVELOPING ROLLER

(71) Applicant: SUMITOMO RUBBER INDUSTRIES, LTD., Hyogo (JP)

(72) Inventor: SHUNSUKE KOSAKA, Hyogo (JP)

(73) Assignee: SUMITOMO RUBBER INDUSTRIES, LTD., Hyogo (JP)

(21) Appl. No.: 18/501,023

(22) Filed: Nov. 2, 2023

(30) Foreign Application Priority Data
Feb. 21, 2023 (JP) 2023-025286

(51) Int. Cl. G03G 15/08

(52) U.S. Cl. CPC G03G 15/0818; G03G 2215/0861

(57) ABSTRACT

A developing roller includes an electro-conductive shaft core and an elastic layer provided on an outer peripheral surface of the electro-conductive shaft core. The elastic layer includes a base layer formed of a rubber composition and an outermost layer formed on a surface of the base layer. The outermost layer is formed of a resin and is an incomplete film including a plurality of through-holes. A ratio of portions other than the through-holes of the outermost layer is 25% to 45% with respect to a total surface area of the elastic layer.

### CROSS-REFERENCE TO RELATED APPLICATION

This application claims the priority benefit of Japan application serial no. 2023-025286, filed on Feb. 21, 2023. The entirety of the above-mentioned patent application is hereby incorporated by reference herein and made a part of this specification.

### BACKGROUND

### Technical Field

The disclosure relates to a developing roller used in an image forming apparatus utilizing an electrophotographic method.

### Related Art

In an image forming apparatus utilizing the electrophotographic method, such as a laser printer, an electrostatic copier, a plain paper facsimile machine, or a multi-function machine combining these apparatuses, a developing roller is used to expose a surface of a charged photoreceptor to develop an electrostatic latent image formed on the surface into a toner image.

In the image development using a developing roller, the developing roller is provided in a developing part accommodating a toner of the image forming apparatus, a tip of a quantity control blade (charging blade) is arranged in the vicinity of the developing roller, and the developing roller is rotated. Then, the toner in the developing part is charged and adhered to an outer peripheral surface of a roller body, and when the adhered toner passes through a nip part between the outer peripheral surface of the roller body and the tip of the quantity control blade, the thickness of the adhered toner is leveled over almost the entire width of the outer peripheral surface to form a toner layer on the outer peripheral surface. Concurrently, on the surface of the photoreceptor, an electrostatic latent image is formed by uniformly performing charging and then exposure. Then, in this state, upon further rotating the developing roller and conveying the toner layer to the vicinity of the surface of the photoreceptor, the toner forming the toner layer selectively moves to the surface of the photoreceptor in accordance with the electrostatic latent image formed on the surface of the photoreceptor, and the electrostatic latent image is developed into a toner image.

In such an image forming apparatus, image defects may occur due to the developing roller, and techniques have been proposed to suppress such image defects. For example, Patent Document 1 (Japanese Patent Application Laid-Open No. 2021-175997) describes a developing roller that includes a roller body in a tubular shape composed of an elastic material, and a silica particle layer composed of silica particles provided at an outermost layer of the roller body (see Patent Document 1 (claim 1)).

Although a developing roller that suppresses occurrence of image defects has been proposed, there is still room for improvement.

### SUMMARY

A developing roller of the embodiments of the disclosure includes an electro-conductive shaft core and an elastic layer provided on an outer peripheral surface of the electro-conductive shaft core. The elastic layer includes a base layer formed of a rubber composition and an outermost layer formed on a surface of the base layer. The outermost layer is formed of a resin and is an incomplete film including a plurality of through-holes. A ratio of portions other than the through-holes of the outermost layer is 25% to 45% with respect to a total surface area of the elastic layer.

By using the developing roller of the embodiments of the disclosure in an image forming apparatus, it is possible to reduce occurrence of image defects arising from the developing roller.

### BRIEF DESCRIPTION OF DRAWINGS

FIG. 1 is a perspective view showing an overall appearance of an example of a developing roller of the disclosure.

FIG. 2 is an end surface view of the developing roller in FIG. 1.

FIG. 3 is a photograph as a drawing showing an outermost layer of a developing roller No. 3.

### DESCRIPTION OF EMBODIMENTS

Embodiments of the disclosure provide a developing roller capable of reducing occurrence of image defects arising from the developing roller.

### <Developing Roller>

A developing roller of the disclosure includes an electro-conductive shaft core and an elastic layer provided on an outer peripheral surface of the electro-conductive shaft core.

### (Electro-Conductive Shaft Core)

The electro-conductive shaft core is not particularly limited as long as it has electrical conductivity at least on a surface and functions as a support of the developing roller. A diameter of the electro-conductive shaft core is not particularly limited, but is generally 4.0 mm to 12.0 mm. Examples of the electro-conductive shaft core may include a metal shaft core, and examples of the metal constituting the metal shaft core may include aluminum, aluminum alloy, and stainless steel.

### (Elastic Layer)

The elastic layer is, for example, electrically bonded and mechanically fixed to the electro-conductive shaft core via an adhesive having electrical conductivity, or is electrically bonded and mechanically fixed to the electro-conductive shaft core by press-fitting an electro-conductive shaft core, which has an outer diameter larger than an inner diameter of a penetration hole of the elastic layer, into the penetration hole. Alternatively, both methods may be used in combination to electrically bond and mechanically fix the elastic layer to the electro-conductive shaft core.

The elastic layer includes a base layer formed of a rubber composition and an outermost layer formed on a surface of the base layer.

A surface hardness of the elastic layer in MD-1 hardness is preferably 37.5 or more, more preferably 37.8 or more, and even more preferably 38.0 or more. If the surface hardness is 37.5 or more in MD-1 hardness, occurrence of white streaks is further suppressed when forming a solid black image. The upper limit of the surface hardness is not particularly limited, but is preferably 60 or less, more preferably 50 or less, and even more preferably 45 or less in MD-1 hardness.

A dynamic friction coefficient of the elastic layer is preferably 1.8 or more, more preferably 1.9 or more, and even more preferably 2.0 or more, and is preferably 3.6 or less, more preferably 3.3 or less, and even more preferably 3.0 or less. If the dynamic friction coefficient is 1.8 or more, toner easily adheres to the surface of the developing roller, and it becomes easy to form a high-density image. If the dynamic friction coefficient is 3.6 or less, it becomes easy to remove residual toner on the surface of the developing roller, and toner fixing to a charging blade is further suppressed.

A thickness of the elastic layer is preferably 1 mm or more and more preferably 2 mm or more, and is preferably 10 mm or less and more preferably 5 mm or less.

### (Base Layer)

The base layer is formed of a rubber composition, is a layer having elasticity, and preferable has electrical conductivity. Examples of the rubber composition may include a rubber composition containing a base rubber, an electro-conductive material, and a vulcanizing agent.

The type of the base rubber is not particularly limited, and a rubber conventionally used in a developing roller may be used. Examples of the base rubber may include diene-based rubber, epichlorohydrin rubber, and ethylene-α-olefin-diene copolymer. One type of these base rubbers may be used alone or two or more types may be used in combination.

The diene-based rubber imparts good processability to the rubber composition and improves the mechanical strength and durability of the base layer. Examples of the diene-based rubber may include natural rubber, isoprene rubber (IR), chloroprene rubber (CR), acrylonitrile butadiene rubber (NBR), styrene butadiene rubber (SBR), and butadiene rubber (BR). Among these, isoprene rubber, chloroprene rubber, and acrylonitrile butadiene rubber are preferable as the diene-based rubber.

The chloroprene rubber is synthesized by subjecting chloroprene to emulsion polymerization, and depending on the type of molecular weight regulator used at this time, the chloroprene rubber is classified into a sulfur-modified type and a non-sulfur-modified type. Further, the non-sulfur-modified type is classified into a mercaptan-modified type, a xanthogen-modified type, etc. Further, the chloroprene rubber may include a copolymer of chloroprene and another copolymerization component. Examples of the another copolymerization component may include one or more of 2,3-dichloro-1,3-butadiene, 1-chloro-1,3-butadiene, styrene, acrylonitrile, methacrylonitrile, isoprene, butadiene, acrylic acid, acrylic acid ester, methacrylic acid, and methacrylic acid ester.

The chloroprene rubber includes an oil-extended type in which extender oil is added to adjust flexibility, and a non-oil-extended type in which no extender oil is added. To prevent contamination of a photoreceptor, the disclosure preferably uses the non-oil-extended type not containing extender oil which may become a bleed substance.

The acrylonitrile butadiene rubber may include any of various types of acrylonitrile butadiene rubber that is synthesized by copolymerizing acrylonitrile and butadiene using various polymerization methods such as emulsion polymerization and has crosslinkability. The acrylonitrile butadiene rubber may include any of low nitrile NBR with an acrylonitrile content of 24 mass % or less, medium nitrile NBR with an acrylonitrile content of 25 mass % to 30 mass %, medium-high nitrile NBR with an acrylonitrile content of 31 mass % to 35 mass %, high nitrile NBR with an acrylonitrile content of 36 mass % to 42 mass %, and ultra-high nitrile NBR with an acrylonitrile content of 43 mass % or more.

Although the acrylonitrile butadiene rubber includes an oil-extended type in which extender oil is added to adjust flexibility and a non-oil-extended type in which no extender oil is added, the non-oil-extended type is preferable.

In the case where the base rubber contains the diene-based rubber, a content of the diene-based rubber in 100 parts by mass of the base rubber is preferably 50 mass % or more and more preferably 60 mass % or more, and is preferably 90 mass % or less and more preferably 85 mass % or less.

The epichlorohydrin rubber may include various polymers containing epichlorohydrin as a repeating unit. Examples of the epichlorohydrin rubber may include one or more of epichlorohydrin homopolymer (CO), epichlorohydrin-ethylene oxide binary copolymer (ECO), epichlorohydrin-propylene oxide binary copolymer, epichlorohydrin-allyl glycidyl ether binary copolymer, epichlorohydrin-ethylene oxide-allyl glycidyl ether ternary copolymer (GECO), epichlorohydrin-propylene oxide-allyl glycidyl ether ternary copolymer, and epichlorohydrin-ethylene oxide-propylene oxide-allyl glycidyl ether quaternary copolymer. Among these examples, a copolymer containing ethylene oxide, particularly ECO and/or GECO, is preferable as the epichlorohydrin rubber.

In the case where the base rubber contains the epichlorohydrin rubber, a content of the epichlorohydrin rubber in 100 parts by mass of the base rubber is preferably 9 mass % or more and more preferably 12 mass % or more, and is preferably 40 mass % or less and more preferably 32 mass % or less.

The ethylene-α-olefin-diene copolymer is a copolymer in which a small amount of diene component is added to ethylene and α-olefin to introduce a double bond into the main chain. Examples of the α-olefin may include propylene, 1-butene, 1-hexene, and 1-octene. Examples of the diene component may include ethylidene norbornene (ENB), 1,4-hexadiene (1,4-HD), and dicyclopentadiene (DCP), and ethylidene norbornene is preferable. Examples of the ethylene-α-olefin-diene copolymer may include ethylene-propylene-diene copolymer (EPDM), ethylene-butene-diene copolymer (EBDM), and ethylene-propylene-butene-diene copolymer (EPBDM).

Although the ethylene-α-olefin-diene copolymer includes an oil-extended type in which extender oil is added to adjust flexibility and a non-oil-extended type in which no extender oil is added, the non-oil-extended type is preferable.

In the case where the base rubber contains the ethylene-α-olefin-diene copolymer, a content of the epichlorohydrin rubber in 100 parts by mass of the base rubber is preferably 1 mass % or more and more preferably 3 mass % or more, and is preferably 10 mass % or less and more preferably 8 mass % or less.

### (Electro-Conductive Material)

Examples of the electro-conductive material may include carbon black and ionic electro-conductive agent. One type of the electro-conductive material may be used alone or two or more types may be used in combination.

The type of the carbon black is not particularly limited. Examples of the carbon black may include furnace carbon black such as super abrasion furnace black (SAF), intermediate super abrasion furnace black (ISAF), intermediate ISAF (IISAF), high abrasion furnace black (HAF), medium abrasion furnace black (MAF), fast extruding furnace black (FEF), semi-reinforcing furnace black (SRF), general purpose furnace black (GPF), fine furnace black (FF), and conductive furnace black (CF), thermal carbon black such as fine thermal black (FT) and medium thermal black (MT), channel carbon black such as easy processing channel Black (EPC) and medium processing channel black (MPC), and acetylene black. One type of the carbon black may be used alone or two or more types may be used in combination.

With respect to 100 parts by mass of the base rubber, a content of the carbon black in the rubber composition is preferably 3 parts by mass or more and more preferably 4 parts by mass or more, and is preferably 15 parts by mass or less and more preferably 10 parts by mass or less.

Examples of the ionic electro-conductive agent may include quaternary ammonium salt, metal salt of carboxylic acid, carboxylic acid derivative such as anhydride or ester of carboxylic acid, condensate of aromatic compound, organometallic complex, metal salt, chelate compound, monoazo metal complex, acetylacetonate metal complex, hydroxycarboxylic acid metal complex, polycarboxylic acid metal complex, and polyol metal complex. One type of the ionic electro-conductive agent may be used alone or two or more types may be used in combination.

In particular, LiOSO₂CF₃, LiOSO₂C₃F₇, LiOSO₂C₄F₉, LIN(CF₃SO₂)₂, LIN(C₄F₉SO₂)₂, LiC(CF₃SO₂)₃, LiCH(CF₃SO₂)₂, KOSO₂CF₃, KOSO₂C₃F₇, KOSO₂C₄F₉, KN(CF₃SO₂)₂, KN(C₄F₉SO₂)₂, KC(CF₃SO₂)₃, and KCH(CF₃SO₂)₂ are preferable as the ionic electro-conductive agent. With respect to 100 parts by mass of the base rubber, a content of the ionic electro-conductive agent in the rubber composition is preferably 0.05 parts by mass or more and more preferably 0.1 parts by mass or more, and is preferably 1.0 part by mass or less and more preferably 0.5 parts by mass or less.

### (Vulcanizing Agent)

Examples of the vulcanizing agent may include one or more of sulfur-based vulcanizing agent, thiourea-based vulcanizing agent, triazine derivative-based vulcanizing agent, peroxide vulcanizing agent, and various monomers. The sulfur-based vulcanizing agent is preferable as the vulcanizing agent.

Examples of the sulfur-based vulcanizing agent may include elemental sulfur and sulfur donor type compound. Examples of the elemental sulfur may include powdered sulfur, precipitated sulfur, colloidal sulfur, and insoluble sulfur. Examples of the sulfur donor type compound may include 4,4′-dithiodimorpholine. One type of the sulfur-based vulcanizing agent may be used alone or two or more types may be used in combination.

With respect to 100 parts by mass of the base rubber, a total content of the vulcanizing agent is preferably 0.5 parts by mass or more, more preferably 1.0 part by mass or more, and even more preferably 2.0 parts by mass or more, and is preferably 5.0 parts by mass or less, more preferably 4.0 parts by mass or less, and even more preferably 3.0 parts by mass or less. If the content is 0.5 parts by mass or more, the compression set is smaller, and the mechanical strength of the rubber roller is further improved. If the content is 5.0 parts by mass or less, occurrence of blooming is further suppressed during long-term storage and use.

The rubber composition may include additives such as vulcanization accelerator, vulcanization aid, acid acceptor, filler, anti-aging agent, processing aid, lubricant, and dispersing agent as needed. These additives may be appropriately selected as ones with which blooming and bleeding are less likely to occur.

### (Vulcanization Accelerator)

The rubber composition may contain a vulcanization accelerator. The vulcanization accelerator may include any of inorganic accelerator and organic accelerator. Examples of the inorganic accelerator may include slaked lime, magnesia (MgO), and litharge (PbO). Examples of the organic accelerator may include thiuram-based accelerator, thiourea-based accelerator, thiazole-based accelerator, guanidine-based accelerator, sulfenamide-based accelerator, and dithiocarbamate salt-based accelerator. One type of the vulcanization accelerator may be used alone or two or more types may be used in combination.

Examples of the thiuram-based accelerator may include tetramethylthiuram monosulfide, tetramethylthiuram disulfide, tetraethylthiuram disulfide, tetrabutylthiuram disulfide, tetrakis(2-ethylhexyl)thiuram disulfide, and dipentamethylenethiuram tetrasulfide, and tetramethylthiuram monosulfide is preferable.

Examples of the thiourea-based accelerator may include ethylenethiourea, trimethylthiourea, N,N′-diethylthiourea, tributylthiourea, dibutylthiourea, dilaurylthiourea, and N,N′-diphenylthiourea. Among these, ethylene thiourea is preferable.

Examples of the guanidine-based accelerator may include 1,3-diphenylguanidine and 1,3-di-o-tolylguanidine.

Examples of the thiazole-based accelerator may include 2-mercaptobenzothiazole, di-2-benzothiazolyl disulfide, zinc salt of 2-mercaptobenzothiazole, cyclohexylamine salt of 2-mercaptobenzothiazole, 2-(N,N-diethylthiocarbamoylthio)benzothiazole, and 2-(4′-morpholinodithio)benzothiazole, and di-2-benzothiazolyl disulfide is preferable.

With respect to 100 parts by mass of the base rubber, a total content of the vulcanization accelerator is preferably 0.1 parts by mass or more, more preferably 0.2 parts by mass or more, and even more preferably 0.3 parts by mass or more, and is preferably 5 parts by mass or less, more preferably 4 parts by mass or less, and even more preferably 3 parts by mass or less.

### (Vulcanization Aid)

Examples of the vulcanization aid may include one or more of metal compound such as zinc oxide (zinc white), fatty acid such as stearic acid, oleic acid, and cottonseed oil, and other conventionally known vulcanization aid. A total content of the vulcanization aid is preferably 0.1 parts by mass or more and is preferably 7 parts by mass or less with respect to 100 parts by mass of the base rubber.

### (Acid Acceptor)

The acid acceptor prevents chlorine-based gas generated from CR and the like during vulcanization of the rubber component from remaining in the electro-conductive roller, and thus prevents occurrence of vulcanization inhibition and contamination of members (e.g., photoreceptor drum) in contact with the electro-conductive roller. Various substances that act as acid receptors may be used as the acid acceptor, among which hydrotalcite or magsarat with excellent dispersibility is preferable, and hydrotalcite is particularly preferable. With respect to 100 parts by mass of the rubber component, the amount of the acid acceptor used is preferably 0.5 parts by mass or more and more preferably 1 part by mass or more, and is preferably 8 parts by mass or less and more preferably 6 parts by mass or less.

### (Anti-Aging Agent)

Examples of the anti-aging agent may include 4,4′-dicumyldiphenylamine, nickel diethyldithiocarbamate, and nickel dibutyldithiocarbamate.

The rubber composition may form the elastic layer in a porous structure. In that case, examples of the method of forming the elastic layer as a porous structure may include balloon foaming and chemical foaming. In the balloon foaming, microballoons are included in the rubber composition, and the microballoons are expanded by heating to cause foaming. The rubber composition may also be formulated with already expanded microballoons and then molded. In the chemical foaming, a foaming agent (azodicarbonamide, azobisisobutyronitrile, N,N-dinitrosopentamethylenetetramine, p-toluenesulfonyl p-hydrazine, oxybis(benzenesulfohydrazide), etc.) and a foaming aid are included in the rubber composition, and a gas (carbon dioxide, nitrogen gas, etc.) is generated by a chemical reaction to cause foaming.

The rubber composition may be prepared by mixing the raw materials and kneading with a pressure kneader, a Banbury mixer, an open roll, etc. The kneading method and conditions are appropriately selected according to the production scale.

### (Method of Forming Base Layer)

To form the base layer, first, the prepared rubber composition is extruded into a tubular shape using an extruder, and is then cut to a predetermined length and is pressurized and heated in a vulcanizing can to cause crosslinking. Then, the crosslinked (and foamed) tubular body is heated using an oven or the like to cause secondary crosslinking, and is cooled to form a base layer. Herein, an outer peripheral surface may be polished to have a predetermined outer diameter. The polishing method may include various polishing methods such as dry traverse polishing.

The electro-conductive shaft core may be inserted and fixed into the penetration hole of the base layer at any time point from after cutting of the tubular body to after polishing. However, after cutting, secondary crosslinking and polishing are preferably performed with the electro-conductive shaft core first inserted into the penetration hole. Accordingly, it is possible to suppress warping or deformation of the base layer due to expansion and contraction during secondary crosslinking. Further, by performing polishing while rotating around the electro-conductive shaft core as a center, it is possible to improve workability of the polishing and suppress deflection of the outer peripheral surface.

The electro-conductive shaft core may be arranged by press-fitting a shaft core, which has an outer diameter larger than an inner diameter of the penetration hole of the tubular body, into the penetration hole, or inserting into the penetration hole of the tubular body before secondary crosslinking via a thermosetting adhesive having electrical conductivity. In the former case, electrical bonding and mechanical fixing with the base layer are completed at the same time as press-fitting of the electro-conductive shaft core. In the latter case, when the tubular body is subjected to secondary crosslinking by hearting in an oven, the thermosetting adhesive hardens at the same time to electrically bond and mechanically fix the electro-conductive shaft core to the base layer. Further, as described above, both methods may be used in combination to electrically bond and mechanically fix the electro-conductive shaft core to the base layer.

The base layer may have a one-layer structure or a multi-layer structure with two or more layers. In the case where the base layer has a multi-layer structure, each layer may be formed of the same rubber composition or may be formed of rubber compositions having different constituents.

A thickness of the base layer is preferably 1 mm or more and more preferably 2 mm or more, and is preferably 10 mm or less and more preferably 5 mm or less.

The surface of the base layer may be surface-modified by dry treatment such as electron beam, ultraviolet light, or corona discharge. The surface of the base layer is preferably treated with ultraviolet light irradiation. Further, the base layer is preferably provided with an oxide film formed on its outer peripheral surface. The oxide film is a film formed by oxidizing the base rubber. The oxide film may be formed on the surface of the base layer by treating with ultraviolet light irradiation in the presence of oxygen.

In the case of forming the oxide film, a thickness of the oxide film may be appropriately adjusted.

In the case of forming the oxide film on the surface of the base layer by performing ultraviolet light irradiation treatment, a low-pressure mercury lamp is preferably used. Since the low-pressure mercury lamp mainly emits ultraviolet light with wavelengths of 185 nm and 254 nm, it is possible to efficiently modify the surface of the base layer. Further, in the case of using a low-pressure mercury lamp, the amount of ultraviolet light irradiation is preferably 100 mJ/cm² to 5000 mJ/cm².

### (Outermost Layer)

The elastic layer includes an outermost layer formed on the surface of the base layer. The outermost layer is formed at the surface of the elastic layer.

The outermost layer is an incomplete film formed of a resin. An incomplete film refers to a film that has multiple through-holes penetrating in the thickness direction. In other words, the surface of the elastic layer is provided with portions where the base layer is covered by the outermost layer and portions where the base layer is exposed. By providing such an outermost layer, it is possible to suppress toner fixing to a blade arranged in the vicinity of the developing roller, and it is possible to prevent occurrence of image defects. A plan view shape of the through-hole included in the incomplete film is not particularly limited, and all has a maximum diameter of 50 μm or less. The maximum diameter of the through-hole may be measured by observing the outermost layer with a microscope.

The melting point of the resin forming the outermost layer is preferably 120° C. or higher, more preferably 125° C. or higher, and even more preferably 130° C. or higher. If the melting point of the resin is 120° C. or higher, occurrence of white streaks when forming a solid black image is further suppressed. The upper limit of the melting point of the resin is not particularly limited, but is preferably 150° C. or lower, and more preferably 140° C. or lower.

The resin is not particularly limited as long as it is a thermoplastic resin. Examples of the resin may include polyolefin resin (polyethylene resin, polypropylene resin, etc.), polyester resin (polyethylene terephthalate resin, polybutylene terephthalate resin, etc.), polyamide resin (nylon 6, nylon 66, copolymer nylon), polyurethane resin, polyacrylic resin, and ethylene-acrylic copolymer resin. Among these, polyolefin resin is preferable, and high-density polyethylene resin is preferable. The high-density polyethylene resin has a density of 0.94 g/cm³ or more at 23° C. The density is measured in accordance with JIS K6922-1 (2018).

In the incomplete film, a ratio of the portions other than the through-holes in the area of the incomplete film is preferably 25% or more and more preferably 26% or more, and is preferably 45% or less and more preferably 40% or less. If the ratio is in the above range, occurrence of white streaks when forming a solid black image is suppressed.

A thickness of the outermost layer is preferably 2 μm or more, more preferably 3 μm or more, and even more preferably 5 μm or more, and is preferably 20 μm or less, more preferably 15 μm or less, and even more preferably 10 μm or less. If the thickness of the outermost layer is 2 μm or more, the effect created by the outermost layer becomes greater, and it is possible to further suppress occurrence of image defects. If the thickness of the outermost layer is 20 μm or less, the influence on the surface resistance value of the roller due to the outermost layer is further suppressed, and the performance of the developing roller is further improved.

A basis weight of the outermost layer is preferably 5 mg/cm² or more, more preferably 10 mg/cm² or more, and even more preferably 15 mg/cm² or more, and is preferably 50 mg/cm² or less, more preferably 40 mg/cm² or less, and even more preferably 35 mg/cm² or less. If the basis weight is 5 mg/cm² or more, the effect created by the outermost layer becomes greater, and it is possible to further suppress occurrence of image defects. If the basis weight is 50 mg/cm² or less, the influence on the surface resistance value of the roller due to the outermost layer is further suppressed, and the performance of the developing roller is further improved.

### (Method of Forming Outermost Layer)

The method of forming the outermost layer is not particularly limited as long as an incomplete film can be formed. Examples of the method of forming the outermost layer may include a method of applying resin powder to the entire surface of the base layer and melting the resin at a predetermined temperature. In the incomplete film, by controlling the amount of resin powder applied to the surface of the base layer and the temperature and time for melting the resin, it is possible to control the ratio of the portions other than the through-holes in the incomplete film.

Examples of the method of applying the resin powder to the surface of the base layer may include a method of coating the resin powder on the surface of the base layer, and a method of placing the resin powder in a container and pressing the surface of the base layer against the container. Further, when applying the resin powder to the surface of the base layer, excess resin powder is preferably removed using a cloth or brush.

A volume median diameter (particle diameter corresponding to 50% accumulation in the volume cumulative distribution with the small diameter side set to 0) of the resin powder according to the Coulter method is preferably 30 μm or less, more preferably 20 μm or less, and even more preferably 15 μm or less. If the volume median diameter is 30 μm or less, it becomes easy to uniformly apply the resin powder to the surface of the base layer. The lower limit of the volume median diameter is not particularly limited, but is preferably 1 μm or more. If the volume median diameter is 1 μm or more, workability when applying the resin powder is improved.

An amount of the resin powder applied to the surface of the base layer per 1 cm² of the base layer is preferably 5 mg or more, more preferably 10 mg or more, and even more preferably 15 mg or more, and is preferably 50 mg or less, more preferably 40 mg or less, and even more preferably 35 mg or less. If the application amount is 5 mg or more per 1 cm² of the base layer, the effect created by the outermost layer becomes greater, and it is possible to further suppress occurrence of image defects. If the application amount is 50 mg or less, the effect on the surface resistance value of the roller due to the outermost layer is further suppressed, and the performance of the developing roller is further improved.

Regarding the heat treatment temperature (atmospheric temperature) when melting the resin powder, with the heat treatment temperature being T1 and the melting point of the resin being T2, a difference (T1-T2) is preferably 0° C. or higher, more preferably 5° C. or higher, and even more preferably 10° C. or higher. If the difference (T1-T2) is 0° C. or higher, the outermost layer can be formed. The upper limit of the difference (T1-T2) is not particularly limited, but is preferably 50° C. or less, and more preferably 40° C. or less. If the difference (T1-T2) is 50° C. or less, it is possible to suppress adverse effects on the elastic layer due to the heat treatment.

The heat treatment time for melting the resin powder is not particularly limited and may be appropriately adjusted according to the melting point of the resin and the heat treatment temperature.

### EMBODIMENTS

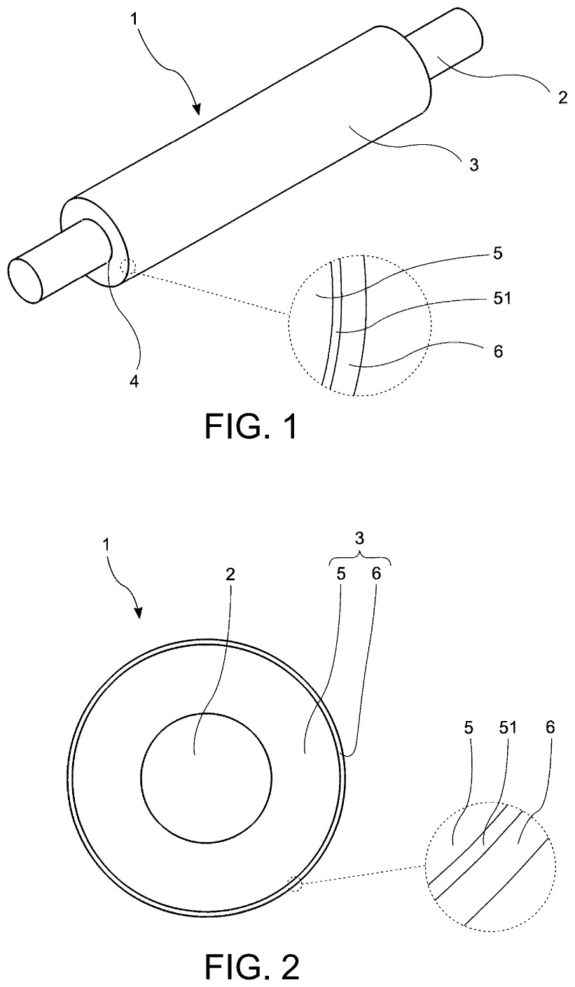

Referring to FIG. 1 and FIG. 2, an example of an embodiment of the developing roller of the disclosure will be described. FIG. 1 is a perspective view showing an overall appearance of an example of the developing roller of the disclosure. FIG. 2 is a side view of the developing roller in FIG. 1.

A developing roller 1 of the disclosure includes an electro-conductive shaft core 2 and an elastic layer 3 provided on an outer peripheral surface of the electro-conductive shaft core 2. The elastic layer 3 is formed of a rubber composition and is formed in a cylindrical shape. The electro-conductive shaft core 2 is inserted and fixed into a penetration hole 4 at a center of the elastic layer.

The electro-conductive shaft core 2, for example, is electrically bonded and mechanically fixed to the elastic layer 3 via an adhesive having electrical conductivity, or is electrically bonded and mechanically fixed to the elastic layer 3 by press-fitting an electro-conductive shaft core, which has an outer diameter larger than an inner diameter of the penetration hole 4 of the elastic layer 3, into the penetration hole. Alternatively, both methods may be used in combination to electrically bond and mechanically fix the electro-conductive shaft core 2 to the elastic layer 3.

The elastic layer 3 includes a base layer 5 formed of a rubber composition and an outermost layer 6 formed on a surface of the base layer. The base layer 5 has a one-layer structure. Further, as shown in the enlarge views in FIG. 1 and FIG. 2, the base layer 5 is provide with an oxide film 51 formed on the outer peripheral surface of the base layer 5.

When expressed in a common logarithmic value logR, a surface resistance value R (52) of the elastic layer measured in a normal-temperature and normal-humidity environment of a temperature of 23° C. and a relative humidity of 55% is preferably 6.5 or more and more preferably 6.8 or more, and is preferably 9.0 or less and more preferably 8.5 or less. A method of measuring the surface resistance value of the elastic layer will be described later.

### EXAMPLES

Although the disclosure will be described in detail according to examples below, the disclosure is not limited to these examples, and any modifications and embodiments that do not depart from the spirit of the disclosure are included within the scope of the disclosure.

### [Evaluation Method]

(1) Ratio of Portions Other than Through-Holes

The outermost layer of the developing roller was photographed using a microscope (manufactured by Keyence, model “VHX-7100”, effective magnification of 1000 times). The obtained image was binarized into resin portions and through-hole portions (portions where the base layer is exposed) using built-in software, and the ratio of the area of the resin portions to the total area was calculated.

### (2) Surface Hardness (MD-1)

The surface hardness of the elastic layer was measured using a micro rubber hardness meter (manufactured by Kobunshi Keiki, “MD-1”). The measurement was performed in an environment of a temperature of 23° C. and a relative humidity of 55% using Type A as a push needle and a pressure foot, and a value after 3 seconds upon piercing the measurement sample with the needle was recorded.

### (3) Dynamic Friction Coefficient

The dynamic friction coefficient of the elastic layer was measured using a friction coefficient tester (manufactured by Trinity-Lab, “TL201 Ts”). The measurement was performed under conditions of an environment of a temperature of 23° C. and a relative humidity of 55%, a vertical load of 10 g, a moving speed of 10 mm/see, and a moving distance of 20 mm, using a ball contactor (ball diameter of 1 cm, ball material of SUS), and an average value of the dynamic friction coefficient for the range of the moving distance of 5 mm to 20 mm was determined.

### (4) Surface Resistance Value of Elastic Layer

The surface resistance value R (52, at 10V application) of the elastic layer was measured in a surface resistance mode using a resistivity meter (manufactured by Mitsubishi Chemical Analytech, Hiresta (registered trademark) UP MCP-HT450) and an MCP probe (UA type) (manufactured by Mitsubishi Chemical Analytech). Specifically, the MCP probe was pressed against an axial center part of the outer peripheral surface of the elastic layer with a load of 480 g, and a value after 10 seconds was taken as the surface resistance value R (52, at 10V application) of the elastic layer.

### (5) Image Evaluation

The developing roller was mounted to a cartridge (manufactured by Brother, “TN-29J”) for a laser printer (manufactured by Brother, “HL-L2370DN”), and a halftone image was printed. The printing was carried out under low-temperature and low-humidity conditions of a temperature of 10±1° C. and a relative humidity of 20±1%, on A4 size paper (TANOSEE PPC paper, SNOW WHITE, sold by Otsuka Shokai), printed for 3000 sheets, and presence or absence of image defects was visually confirmed and evaluated according to the following criteria.

### (Solid Black Density)

o: No problem. Δ: The image density is slightly light. x: There is a problem.

### (Vertical Streaks)

o: No vertical streaks. x: Vertical streaks are present.

### [Method of Manufacturing Developing Roller]

### Developing Roller No. 1

### (Base Layer)

The formulation materials shown in Table 1 were kneaded in a Banbury mixer and then extruded into a tube (outer diameter of $14 mm, inner diameter of ¢ 6.5 mm) using an extruder. This tube was mounted to a shaft for vulcanization, was vulcanized at 160° C. for one hour with a vulcanization can, and was then mounted to a core metal ($8.0 mm) coated with an electro-conductive adhesive and adhered in an oven at 160° C. Subsequently, the ends of the tube adhered to the core metal were shaped, traverse polished by a cylindrical polishing machine, and then mirror polished as a finishing polish to form a base layer (¢ 13.00 mm). The mirror polishing was performed with Wrapping Film #600 (manufactured by Sankyo Rikagaku, Mirror Film). Upon polishing, after wiping the outer peripheral surface of the base layer with alcohol, the product was set in an ultraviolet light treatment device to perform surface treatment by ultraviolet light irradiation on the base layer.

TABLE 1
Rubber composition

| | | | |
|---|---|---|---|
| Formulation | Base rubber | Epion 301L | 22.5 |
| (Parts | | Shoprene WRT | 5 |
| by mass) | | Esprene 505A | 5 |
| | | Nipol IR2200 | 62.5 |
| | | Nipol DN401LL | 5 |
| | Electro-conductive | Seast SO (FEF) | 5 |
| | material | Crushed product | 0.1 |
| | | SOLVAY KTFSI | |
| | Crosslinking agent | Sulfur | 1.24 |
| | | Vulnoc R | 1.14 |
| | Vulcanization aid | Zinc oxide | 2.5 |
| | Processing aid | SZ-2000 | 0.5 |
| | Acid acceptor | DHT-4A-2 | 3 |
| | Antioxidant | Nonflex DCD | 1 |
| | Vulcanization | Sanceler TS-G | 0.5 |
| | accelerator | Accel 22S | 0.3 |
| | | Sanceler DT | 0.28 |
| | | MBTS | 1.5 |

Epion (registered trademark) 301L: Manufactured by Osaka Soda, epichlorohydrin rubber
Shoprene (registered trademark) WRT: Manufactured by Showa Denko, chloroprene rubber (non-oil-extended)
Esprene (registered trademark) 505A: Manufactured by Sumitomo Chemical, ethylene propylene diene rubber
Nipol (registered trademark) IR2200: Manufactured by Nippon Zeon, isoprene rubber
Nipol DN401LL: Manufactured by Nippon Zeon, acrylonitrile butadiene rubber (acrylonitrile content 18.0%, non-oil-extended)
Zinc oxide: Manufactured by Mitsui Metal Mining, two types of zinc oxide
DHT-4A-2: Manufactured by Kyowa Chemical Industry, hydrotalcite compound
SZ-2000: Manufactured by Sakai Chemical Industry, zinc stearate
Nonflex DCD: Manufactured by Seiko Chemical, 4,4′-dicumyldiphenylamine
Seast SO: Manufactured by Tokai Carbon, carbon black (FEF)
Crushed product SOLVAY KTFSI: Potassium bis(trifluoromethanesulfonyl)imide
Sanceler (registered trademark) TS-G: Manufactured by Sanshin Chemical Industry, tetramethylthiuram monosulfide
Accel 22S: Manufactured by Kawaguchi Chemical Industry, ethylene thiourea
Sanceler DT: 1,3-di-o-tolylguanidine
MBTS: Manufactured by Shandong Shanxian Chemical, SUNSINE MBTS (di-2-benzothiazyl disulfide)
Sulfur: Manufactured by Tsurumi Chemical Industry, sulfur with 5% oil content
Vulnoc (registered trademark) R: 4,4′-dithiodimorpholine

### (Outermost Layer)

The entire surface of the base layer treated with ultraviolet light was coated with a high-density polyethylene resin powder (manufactured by Sumitomo Seika, “HE-3040”, melting point of 130° C., density of 0.96 g/cm³ (JIS K6922-1 (2018)), median particle diameter (Coulter method) of 11 μm). The powder was dropped any number of times using a cloth, and then melted at any temperature to form an outermost layer (resin layer of incomplete film).

### Developing Rollers No. 2 to 4 and 7 to 9

Except for changing the number of times of dropping the resin powder applied to the surface of the base layer using a cloth, developing rollers No. 2 to 4 and 7 to 9 have been manufactured in the same manner as the manufacturing method of the developing roller No. 1.

### Developing Rollers No. 5 and 6

Except for changing the resin powder applied to the surface of the base layer to resins shown in Table 2, developing rollers No. 5 and 6 have been manufactured in the same manner as the manufacturing method of the developing roller No. 1.

TABLE 2

| Developing roller No. | | | 1 | 2 | 3 | 4 | 5 | 6 | 7 | 8 | 9 |
|---|---|---|---|---|---|---|---|---|---|---|---|
| Formation | | Type of resin | High- | High- | High- | High- | Copolymer | Poly- | High- | High- | High- |
| condition of | | powder | density | density | density | density | nylon | urethane | density | density | density |
| outermost layer | | | poly- | poly- | poly- | poly- | | | poly- | poly- | poly- |
| | | | ethylene | ethylene | ethylene | ethylene | | | ethylene | ethylene | ethylene |
| | | Melting point | 130 | 130 | 130 | 130 | 130 | 130 | 130 | 130 | 130 |
| | | (° C.) of resin | | | | | | | | | |
| | | Volume median | 11 | 11 | 11 | 11 | 10 | 10 | 11 | 11 | 11 |
| | | diameter | | | | | | | | | |
| | | (μm) of resin | | | | | | | | | |
| | | powder | | | | | | | | | |
| | | Number of | 3 rounds | 4 rounds | 6 rounds | 8 rounds | 3 rounds | 3 rounds | 1 round | 2 rounds | 9 rounds |
| | | times of | | | | | | | | | |
| | | dropping | | | | | | | | | |
| | | powder | | | | | | | | | |
| | | Application | 35 | 30 | 20 | 15 | 35 | 35 | 40 | 37 | 12 |
| | | amount | | | | | | | | | |
| | | (mg/cm²) of | | | | | | | | | |
| | | resin powder | | | | | | | | | |
| | | Heat treatment | 150 | 150 | 150 | 150 | 150 | 150 | 150 | 150 | 150 |
| | | temperature | | | | | | | | | |
| | | (° C.) | | | | | | | | | |
| Elastic | Outer- | Type of resin | High- | High- | High- | High- | Copolymer | Poly- | High- | High- | High- |
| layer | most | | density | density | density | density | nylon | urethane | density | density | density |
| | layer | | poly- | poly- | poly- | poly- | | | poly- | poly- | poly- |
| | | | ethylene | ethylene | ethylene | ethylene | | | ethylene | ethylene | ethylene |
| | | Form of film | Incomplete | Incomplete | Incomplete | Incomplete | Incomplete | Incomplete | Incomplete | Incomplete | Incomplete |
| | | | film | film | film | film | film | film | film | film | film |
| | | Thickness | 5 to 10 | 5 to 10 | 5 to 10 | 5 to 10 | 5 to 10 | 5 to 10 | 5 to 10 | 5 to 10 | 5 to 10 |
| | | (μm) | | | | | | | | | |
| | | Ratio (%) of | 39 | 37 | 31 | 26 | 40 | 40 | 54 | 51 | 23 |
| | | portions other | | | | | | | | | |
| | | than through- | | | | | | | | | |
| | | holes | | | | | | | | | |

| | | | | | | | | | | |
|---|---|---|---|---|---|---|---|---|---|---|
| | Surface hardness | 38.1 | 38.1 | 38.1 | 37.5 | 39.0 | 38.5 | 39.2 | 39 | 37 |
| | (MD-1) | | | | | | | | | |
| | Dynamic friction | 2.1 | 2.1 | 2.1 | 2.4 | 2.7 | 2.9 | 1.5 | 1.6 | 2.6 |
| | coefficient | | | | | | | | | |
| | Surface resistance value | 7.8 | 7.8 | 7.8 | 7.8 | 7.8 | 7.8 | 7.8 | 7.8 | 7.8 |
| | (logR) | | | | | | | | | |
| Eval- | Solid black density | ○ | ○ | ○ | ○ | Δ | Δ | x | x | x |
| uation | (visual) | | | | | | | | | |
| | Vertical streak | ○ | ○ | ○ | ○ | ○ | ○ | x | x | x |
| | (visual) | | | | | | | | | |

Copolymer nylon resin powder: Manufactured by Sumitomo Seika, NP-G (melting point of 130° C., median particle diameter (Coulter method) of 10 μm)

Polyurethane resin powder: Manufactured by Tosoh, Pearlthane (registered trademark) U-204A (melting point of 130° C., median particle diameter (Coulter method) of 10 μm)

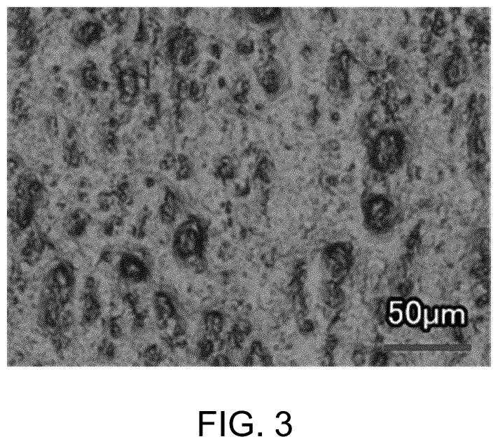

The evaluation results of each developing roller are shown in Table 2. Further, a photograph of the surface of the elastic layer of the developing roller No. 3 is shown in FIG. 3. The developing rollers No. 1 to 6 include a base layer formed of a rubber composition and an outermost layer formed on a surface of the base layer. The outermost layer is formed of a resin and is an incomplete film including a plurality of through-holes, and a ratio of portions other than the through-holes of the outermost layer is 25% to 45% with respect to a total surface area of the elastic layer. These developing rollers No. 1 to 6 have not been found to cause image defects in the printing test.

The developing rollers No. 7 and 8 include a base layer formed of a rubber composition and an outermost layer formed on a surface of the base layer. The outermost layer is formed of a resin and is an incomplete film including a plurality of through-holes, and a ratio of portions other than the through-holes of the outermost layer exceeds 45% with respect to a total surface area of the elastic layer. These developing rollers No. 7 and 8 have been found to cause image defects in the printing test. The developing roller No. 9 includes a base layer formed of a rubber composition and an outermost layer formed on a surface of the base layer. The outermost layer is formed of a resin and is an incomplete film including a plurality of through-holes, and a ratio of portions other than the through-holes of the outermost layer is less than 25% with respect to a total surface area of the elastic layer. The developing roller No. 9 has been found to cause image defects in the printing test.

An embodiment (1) of the disclosure is a developing roller characterized by including an electro-conductive shaft core and an elastic layer provided on an outer peripheral surface of the electro-conductive shaft core. The elastic layer includes a base layer formed of a rubber composition and an outermost layer formed on a surface of the base layer. The outermost layer is formed of a resin and is an incomplete film including a plurality of through-holes. A ratio of portions other than the through-holes of the outermost layer is 25% to 45% with respect to a total surface area of the elastic layer.

An embodiment (2) of the disclosure is the developing roller according to the embodiment (1) of the disclosure, in which the resin is high-density polyethylene.

What is claimed is:

1. A developing roller comprising:
an electro-conductive shaft core and an elastic layer provided on an outer peripheral surface of the electro-conductive shaft core, wherein
the elastic layer comprises a base layer formed of a rubber composition and an outermost layer formed on a surface of the base layer,
the outermost layer is formed of a resin and is an incomplete film comprising a plurality of through-holes, and
a ratio of portions other than the through-holes of the outermost layer is 25% to 45% with respect to a total surface area of the elastic layer.

2. The developing roller according to claim 1, wherein the resin is high-density polyethylene.
